(19) United States
(12) Patent Application Publication
(10) Pub. No.: US 2019/0034653 A1
(43) Pub. Date: Jan. 31, 2019

(54) INFORMATION PROCESSING DEVICE AND CONTROL METHOD FOR INFORMATION PROCESSING DEVICE

(71) Applicant: KYOCERA Document Solutions Inc., Osaka (JP)

(72) Inventor: Manuel BARICUATRO, JR., Osaka (JP)

(73) Assignee: KYOCERA Document Solutions Inc., Osaka (JP)

(21) Appl. No.: 15/685,651

(22) Filed: Aug. 24, 2017

(30) Foreign Application Priority Data
Jul. 27, 2017 (JP) 2017-145475

(51) Int. Cl. G06F 21/62; G06F 21/54

(52) U.S. Cl. CPC G06F 21/6218; G06F 21/54

(57) ABSTRACT

For encryption of an encryption-targeted data segment, the information processing device executes steps of: accepting input of an encryption method of a next data segment as well as a decryption key of the next data segment encrypted by the encryption method; adding, to the encryption-targeted data segment, next-data information including the encryption method and the decryption key; and encrypting the encryption-targeted data segment with the next-data information added thereto, and afterwards for encryption of the next data segment, the information processing device encrypts the next data segment on a basis of the encryption method and the decryption key included in the next-data information of the encryption-targeted data segment.

### INCORPORATION BY REFERENCE

This application is based upon and claims the benefit of priority from the corresponding Japanese Patent Application No. 2017-145475 filed on Jul. 27, 2017, the entire contents of which are incorporated herein by reference.

### BACKGROUND

The present disclosure relates to an information processing device for processing various types of data, as well as to a control method for information processing devices.

Conventionally, there has been known a technique of dividing original data into plural segments and storing the divided plural data segments in storage destinations different from one another, respectively. In conventional cases, a plurality of online storages are prepared beforehand as those storage destinations. Then, a plurality of data segments are stored distributedly.

### SUMMARY

An information processing device in a first aspect of the present disclosure includes an input part, and a control part. The input part accepts an input from a user. The control part divides original data into a plurality of data segments, and encrypts the plurality of data segments one by one in order. For encryption of an encryption-targeted data segment which is one of the data segments to be currently encrypted, when a next data segment which is one of the data segments to be encrypted next to the encryption-targeted data segment is present, the control part executes steps of: instructing the input part to accept input of an encryption method of the next data segment as well as a decryption key necessary for decryption of the next data segment encrypted by the encryption method; adding, to the encryption-targeted data segment, next-data information including the encryption method of the next data segment and the decryption key of the next data segment; and encrypting the encryption-targeted data segment with the next-data information added thereto in such a fashion that the next-data information is encrypted together therewith, and wherein, afterwards for encryption of the next data segment, the control part encrypts the next data segment on a basis of the encryption method and the decryption key included in the next-data information added to the encryption-targeted data segment.

A control method for an information processing device in a second aspect of the disclosure is a method of controlling an information processing device which divides original data into a plurality of data segments and encrypts the plurality of data segments one by one in order. The method includes the steps of: recognizing an encryption-targeted data segment which is one of the data segments to be currently encrypted; accepting input of an encryption method of a next data segment which is one of the data segments to be encrypted next to the encryption-targeted data segment as well as a decryption key necessary for decryption of the next data segment encrypted by the encryption method; extracting the encryption-targeted data segment from the original data; generating combined data composed of the encryption-targeted data segment to which next-data information including the encryption method of the next data segment as well as the decryption key of the next data segment is added; and encrypting the combined data. For encryption of the next data segment, the information processing device encrypts the next data segment on a basis of the encryption method and the decryption key included in the next-data information added to the encryption-targeted data segment.

### BRIEF DESCRIPTION OF THE DRAWINGS

FIG. 1 is a diagram showing an information processing device according to one embodiment of the present disclosure;

FIG. 2 is a chart showing a flow of dividing-and-storing process to be executed by the information processing device according to one embodiment of the disclosure;

FIG. 3 is a view showing combined data to be generated by the information processing device according to one embodiment of the disclosure;

FIG. 4 is a chart showing a flow of dividing-and-storing process to be executed by the information processing device according to one embodiment of the disclosure;

FIG. 5 is a view showing next-data information to be added to a data segment by the information processing device according to one embodiment of the disclosure;

FIG. 6 is a view showing final information to be added to a data segment by the information processing device according to one embodiment of the disclosure;

FIG. 7 is a view showing storage destinations of data segments divided and stored by the information processing device according to one embodiment of the disclosure;

FIG. 8 is a chart showing a flow of reconstructing process to be executed by the information processing device according to one embodiment of the disclosure; and

FIG. 9 is a view showing original data reconstructed by the information processing device according to one embodiment of the disclosure.

### DETAILED DESCRIPTION

<Configuration of Information Processing Device>

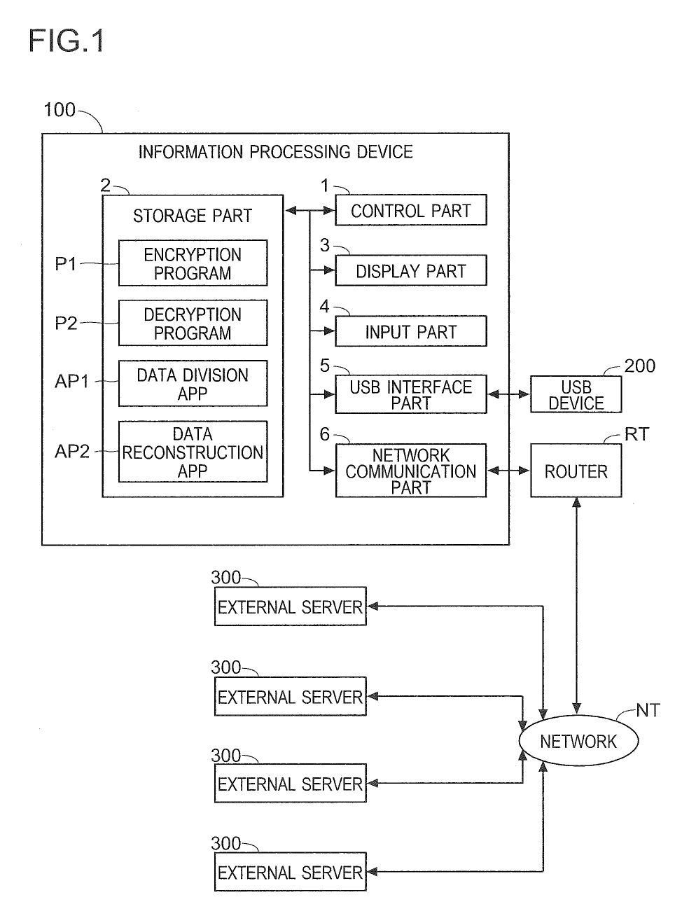

An information processing device 100 of this embodiment has such a configuration as shown in FIG. 1. The information processing device 100 is a note- or desktop-type personal computer as an example. Otherwise, the information processing device 100 may be a mobile terminal such as a smartphone or a tablet terminal.

The information processing device 100 includes a control part 1, a storage part 2, a display part 3, an input part 4, a USB interface part 5, and a network communication part 6.

The control part 1 includes a CPU. The control part 1 operates on a basis of control-dedicated programs and data to execute processing for controlling individual parts of the information processing device 100. The control part 1 performs encryption and decryption processing as will be described later.

The storage part 2 includes nonvolatile memory (ROM) and volatile memory (RAM). The storage part 2 stores control-dedicated programs and data to operate the control part 1 (CPU). The storage part 2 further stores an encryption program P1 for allowing the control part 1 to fulfill encryption process, as well as a decryption program P2 for allowing the control part 1 to fulfill decryption process. Moreover, the storage part 2 stores a data division application AP1 (hereinafter, referred to as data division app AP1) installed on the information processing device 100, and a data reconstruction application AP2 (hereinafter, referred to as data reconstruction app AP2) installed on the information processing device 100.

The display part 3 displays various types of screens. The display part 3 is, for example, a display unit such as an LCD. The input part 4 accepts input operations from a user. The input part 4 is, for example, an input unit such as a hardware keyboard. The control part 1 controls display operations of the display part 3. The control part 1 also detects input operations accepted by the input part 4 from the user.

The USB interface part 5 is an interface for setting a USB device 200 such as a USB memory to the information processing device 100. The USB interface part 5 includes a socket into which a terminal of the USB device 200 is to be fitted, a USB communication circuit for allowing communications to be made with the USB device 200 fitted into the socket, and the like.

The control part 1 controls the USB communication circuit of the USB interface part 5 to communicate with the USB device 200 set to the USB interface part 5. That is, the control part 1 makes data stored in the USB device 200 or read out data from the USB device 200.

The network communication part 6 is an interface for connecting the information processing device 100 to a wide area network NT such as the Internet. For example, the network communication part 6 includes a LAN communication circuit for LAN communications, and the like. The network communication part 6 is connected to a router RT which functions as a wireless LAN access point.

The control part 1 controls the LAN communication circuit of the network communication part 6 to communicate with external devices connected to the wide area network NT. In the following description, it is assumed that an external server 300 as an external device is connected to the wide area network NT. In this case, it is implementable to transmit data from the information processing device 100 to the external server 300 and store the data in the external server 300. Also, the information processing device 100 is allowed to acquire the data stored in the external server 300. For example, a plurality of external servers 300 are connected to the wide area network NT.

<Data Division and Storage>

With the data division app AP1 installed on the information processing device 100, the information processing device 100 (control part 1) is enabled to execute dividing-and-storing process (process including encryption process) including the steps of dividing user-specified original data into a plurality of data segments, encrypting the divided plural data segments on a data-segment basis and storing the encrypted data segments separately from one another. It is noted that dividedly storable data types are not particularly limited. Not only data generated by the information processing device 100 can be dividedly stored, but data inputted to the information processing device 100 via the USB interface part 5 or the network communication part 6 (i.e., data generated in the external) can also be dividedly stored.

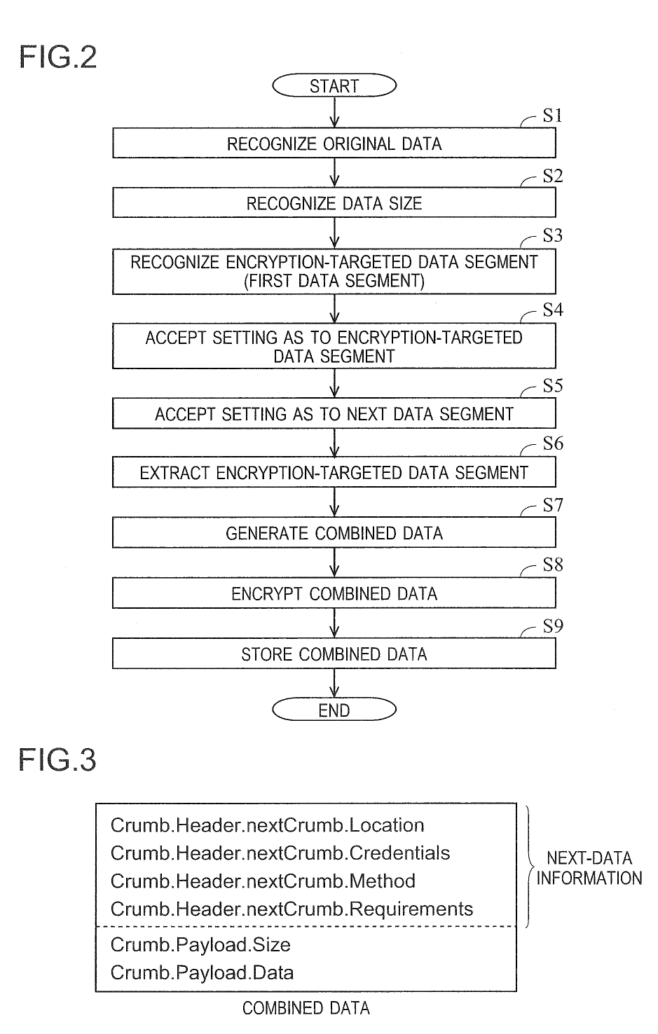

When detecting that the input part 4 has accepted an input operation of instructing a start-up of the data division app AP1, the control part 1 starts up the data division app AP1. Then, the control part 1 executes processing steps according to the flowchart shown in FIG. 2 (dividing-and-storing process including encryption process).

At step S1, the control part 1 recognizes user-specified original data. For example, the control part 1 instructs the display part 3 to display an acceptance screen (not shown) for accepting specification of original data from the user. Then, an input operation of specifying original data is executed on the input part 4.

At step S2, the control part 1 recognizes data size of a first data segment that is first divided from the original data. For example, the control part 1 instructs the display part 3 to display an acceptance screen (not shown) for accepting specification of a data size from the user. Then, an input operation of specifying a data size is executed on the input part 4.

At step S3, the control part 1 recognizes data corresponding to the data size accepted by the input part 4 out of the original data, as an encryption-targeted data segment which is to be currently encrypted. In this case, the first data segment is treated as the encryption-targeted data segment.

At step S4, the control part 1 instructs the display part 3 to display an acceptance screen (not shown) for accepting, from the user, a setting as to the encryption-targeted data segment (first data segment). Then, an input operation for making a setting as to the encryption-targeted data segment (first data segment) is executed on the input part 4. Accepted in this process are an encryption method for the encryption-targeted data segment (first data segment) (hereinafter, this encryption method will be referred to as first-data encryption method), as well as a decryption key necessary for decryption of the encryption-targeted data segment (first data segment) encrypted by the first-data encryption method (hereinafter, this decryption key will be referred to as first-data decryption key). Also accepted are a storage destination of the encryption-targeted data segment (first data segment), as well as an account for accessing the storage destination.

At step S5, the control part 1 instructs the display part 3 to display an acceptance screen (not shown) for accepting, from the user, a setting as to a next data segment (second data segment) which is to be encrypted next to the encryption-targeted data segment (first data segment). Then, an input operation for making a setting as to the next data segment (second data segment) is executed on the input part 4.

Accepted in this process are an encryption method for the next data segment (second data segment), as well as a decryption key necessary for decryption of the next data segment (second data segment) encrypted by the encryption method. Also accepted are a storage destination for the next data segment (second data segment), as well as an account for accessing the storage destination.

At step S6, the control part 1 dividedly separates, from the original data, data corresponding to the data size recognized by the processing of step S2, and extracts the separated data as an encryption target. That is, the control part 1 extracts an encryption-targeted data segment (first data segment) from the original data.

At step S7, the control part 1 generates combined data (Crumb) composed of the encryption-targeted data segment (first data segment) with next-data information added thereto. The next-data information to be added to the encryption-targeted data segment, as shown in FIG. 3, includes various types of information accepted from the user by processing of step S5, i.e., storage destination (nextCrumb.Location), account (nextCrumb.Credentials), encryption method (nextCrumb.Method), and decryption key (nextCrumb.Requirements). For example, the next-data information is added to the encryption-targeted data segment as header information. In addition, in FIG. 3, ‘Payload.Size’ represents a data size of the encryption-targeted data segment, and ‘Payload.Data’ represents data body of the encryption-targeted data segment.

Reverting to FIG. 2, at step S8, the control part 1 executes encryption process to encrypt the next-data-information-added encryption-targeted data segment (first data segment) together with the next-data information. That is, the control part 1 encrypts combined data including the encryption-targeted data segment (first data segment). In this process, the control part 1 executes the encryption on a basis of the first-data encryption method and the first-data decryption key accepted from the user in the process of step S4.

At step S9, the control part 1 recognizes the storage destination of the encryption-targeted data segment (first data segment) accepted from the user in the process of step S4. Then, the control part 1 stores the encrypted encryption-targeted data segment (combined data) in the recognized storage destination. The storage destination of an encryption-targeted data segment may be specified arbitrarily by the user. For example, the storage destination may be the storage part 2 of the information processing device 100, or may be the USB device 200 connected to the information processing device 100, or may be any one of the plural external servers 300.

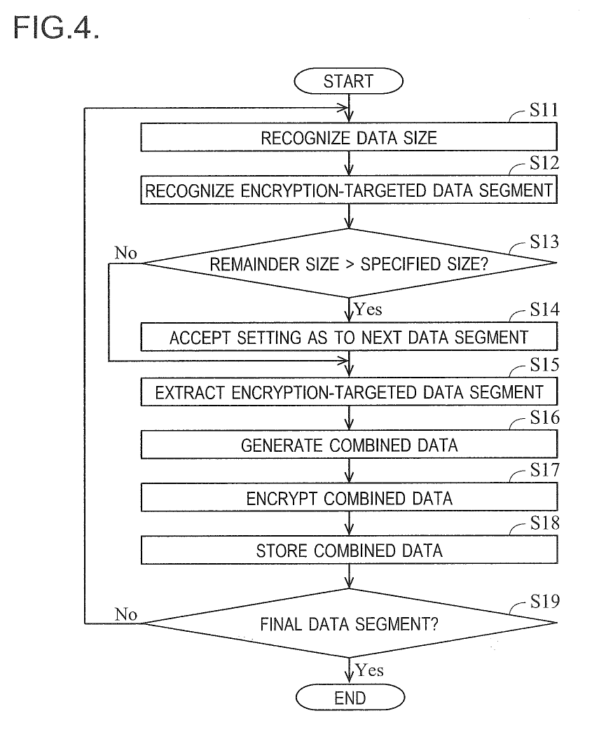

After encrypting and storing the first data segment that has been first divided from the original data, the control part 1 executes processing steps (dividing-and-storing process including encryption process) according to the flowchart shown in FIG. 4.

At step S11, the control part 1 recognizes a data size of a data segment to be next divided from the remaining original data. In this process, the control part 1 instructs the display part 3 to display an acceptance screen for accepting specification of a data size from the user, as in the process of step S2 shown in FIG. 2. Then, an input operation of specifying a data size is executed on the input part 4.

At step S12, the control part 1 recognizes data corresponding to the data size accepted by the input part 4 out of the remaining original data, as a new encryption-targeted data segment (encryption-targeted data segment which is to be currently encrypted).

At step S13, the control part 1 recognizes the data size of the remaining original data including the encryption-targeted data segment, and decides whether or not the recognized data size (remainder size) is larger than the data size recognized by the process of step S11 (specified size by user's specification). As a result, when the control part 1 decides that the remainder size is larger than the user-specified size, the processing flow moves on to step S14.

At step S14, the control part 1 instructs the display part 3 to display an acceptance screen (not shown) for accepting, from the user, a setting as to a next data segment which is to be encrypted next to the encryption-targeted data segment. Then, an input operation for making a setting as to the next data segment is executed on the input part 4. In a case where the encryption-targeted data segment is the second data segment, a setting as to a third data segment (next data segment) is accepted. In another case where the encryption-targeted data segment is the third data segment, a setting as to a fourth data segment (next data segment) is accepted.

Accepted in this process are an encryption method for a next data segment, as well as a decryption key necessary for decryption of the next data segment encrypted by the encryption method. Also accepted are a storage destination for the next data segment, as well as an account for accessing the storage destination.

Upon completion of the process of step S14, the processing flow moves on to step S15. At step S13, when the control part 1 decides that the remainder size is not larger than the specified size, the process of step S14 is skipped, followed by movement to step S15. In this case, the control part 1 determines that the encryption-targeted data segment is a final data segment (data segment to be finally encrypted).

At step S15, the control part 1 divides, from the original data, data corresponding to the data size recognized by the process of step S11, and extracts the divided data as an encryption target to be encrypted just subsequently. That is, the control part 1 extracts an encryption-targeted data segment from the original data. In addition, in a case where the encryption-targeted data segment is the final data segment, an entirety of the remaining original data is extracted as a target of the encrypt to be execute just subsequently.

At step S16, the control part 1 generates combined data composed of the encryption-targeted data segment with next-data information added thereto. The next-data information to be added to the encryption-targeted data segment in this case includes various types of information (storage destination, account, encryption method, and decryption key) accepted from the user in the process of step S14.

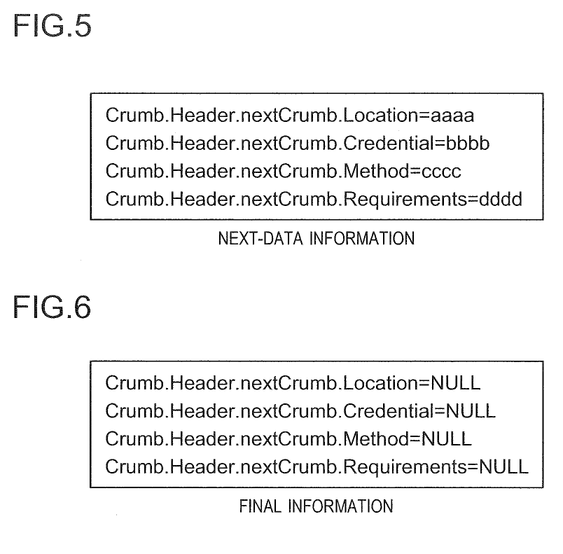

In addition, when the encryption-targeted data segment is a final data segment, the control part 1 adds, to the encryption-targeted data segment, final information indicative of absence of any data segment to be next encrypted, instead of next-data information. For example, in a case where the encryption-targeted data segment is other than a final data segment, the various types of information inputted by the user in the process of step S14 as shown in FIG. 5, i.e. storage destination (nextCrumb.Location), account (nextCrumb.Credentials), encryption method (nextCrumb.Method), and decryption key (nextCrumb.Requirements), are included in the next-data information. Meanwhile, in another case where the encryption-targeted data segment is a final data segment, NULL information is added to the encryption-targeted data segment as final information as shown in FIG. 6.

Reverting to FIG. 4, at step S17, the control part 1 executes encryption process to encrypt the next-data-information-(or final-information-)added encryption-targeted data segment, together with the next-data information (or the final information). That is, the control part 1 encrypts combined data including the encryption-targeted data segment. In this process, the control part 1 recognizes the encryption method and the decryption key indicated by the next-data information of the data segment that has been encrypted just one segment before the encryption-targeted data segment. The control part 1 then encrypts the encryption-targeted data segment on a basis of the recognized encryption method and decryption key. For example, in a case where the encryption-targeted data segment is the second data segment, the encryption-targeted data segment is encrypted on a basis of the encryption method and decryption key indicated by the next-data information of the first data segment. In another case where the encryption-targeted data segment is the third data segment, the encryption-targeted data segment is encrypted on a basis of the encryption method and decryption key indicated by the next-data information of the second data segment.

At step S18, the control part 1 stores the encrypted encryption-targeted data segment (combined data). In this process, the control part 1 recognizes the storage destination indicated by the next-data information of the data segment just one segment before the encryption-targeted data segment. Then, the control part 1 stores the encrypted encryption-targeted data segment in the recognized storage destination. For example, in a case where the encryption-targeted data segment is the second data segment, the encrypted encryption-targeted data segment is stored in the storage destination indicated by the next-data information of the first data segment. In another case where the encryption-targeted data segment is the third data segment, the encrypted encryption-targeted data segment is stored in the storage destination indicated by the next-data information of the second data segment. In addition, the storage destination of an encryption-targeted data segment may be specified arbitrarily by the user. For example, the storage destination may be the storage part 2 of the information processing device 100, or may be the USB device 200 connected to the information processing device 100, or may be any one of the plural external servers 300.

At step S19, the control part 1 decides whether or not the encryption-targeted data segment (combined data) stored by the process of step S18 is a final data segment. As a result, when the control part 1 decides that the encryption-targeted data segment is a final data segment, this processing flow is ended. Meanwhile, when the control part 1 decides that the encryption-targeted data segment is not a final data segment, the processing flow moves on to step S11. That is, processing steps according to the flowchart shown in FIG. 4 are repeated until the encryption of the final data segment is completed.

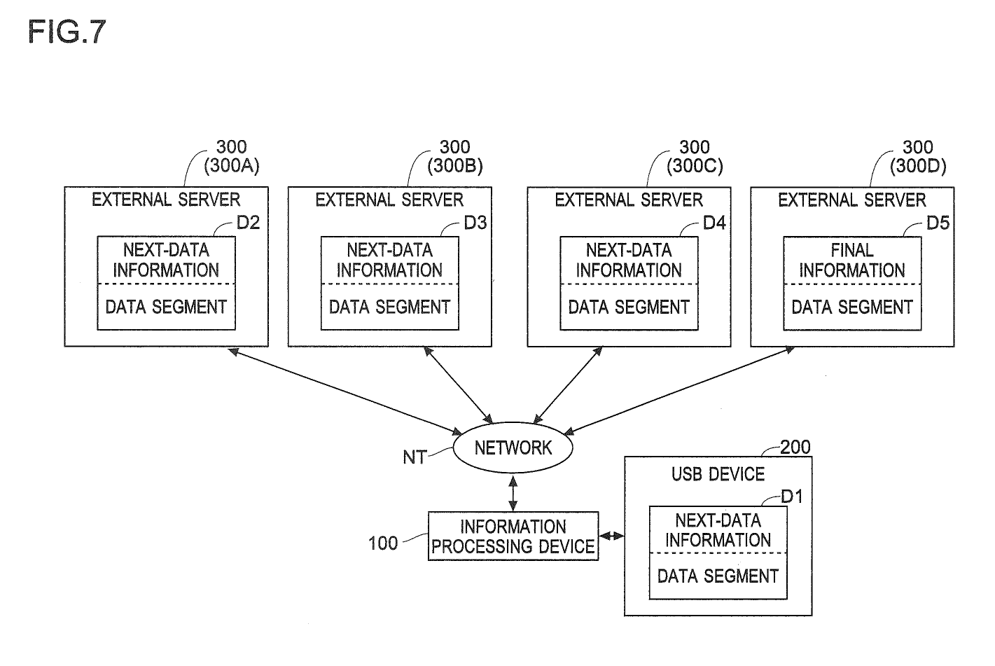

In a case where the original data is divided into five data segments as an example, five combined data units D1, D2, D3, D4 and D5 are generated and encrypted in this order as shown in FIG. 7. In this case, the encrypted five combined data units D1 to D5 may be stored in storage destinations different from one another. Also, the decryption keys of the encrypted combined data units D1 to D5 may be differentiated from one another. FIG. 7 shows a state in which the combined data unit D1 is stored in the USB device 200 set to the information processing device 100 while the combined data units D2 to D5 are stored in plural external servers 300 (300A, 300B, 300C and 300D) communicatably connected to the information processing device 100, respectively.

<Data Reconstruction>

With the data reconstruction app AP2 installed on the information processing device 100, the information processing device 100 (control part 1) is enabled to execute reconstruction process (process including decryption process) of reconstructing original data from a plurality of data segments resulting from division by the data division app AP1.

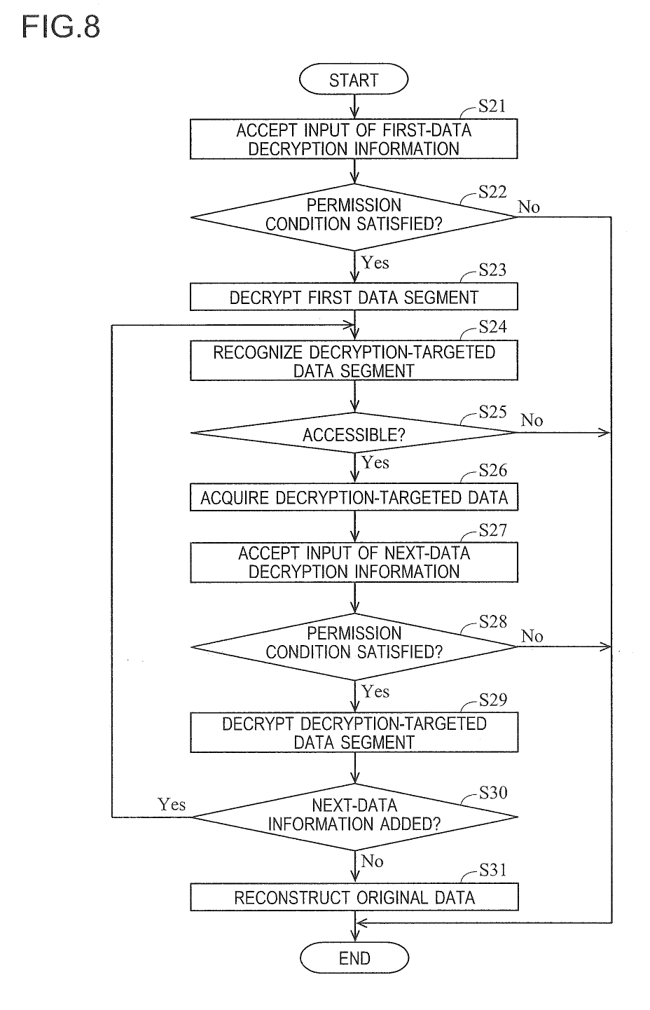

When detecting that the input part 4 has accepted an input operation of instructing a start-up of the data reconstruction app AP2, the control part 1 starts up the data reconstruction app AP2. Then, the control part 1 executes processing steps according to the flowchart shown in FIG. 8 (reconstruction process including decryption process).

At step S21, the control part 1 instructs the display part 3 to display an acceptance screen (not shown) for accepting decryption information for decrypting a first data segment (combined data) with next-data information added thereto (hereinafter, this decryption information will be referred to as first-data decryption information). Then, an input operation of inputting the first-data decryption information is executed on the input part 4.

At step S22, on a basis of the first-data decryption key accepted from the user by the process of step S4 of FIG. 2 as well as the first-data decryption information currently accepted by the input part 4, the control part 1 decides whether or not a permission condition for permitting decryption of the encrypted first data segment is satisfied. As a result, when the control part 1 decides that the permission condition is satisfied, the processing flow moves on to step S23; otherwise, when the control part 1 decides that the permission condition is not satisfied, this processing flow is ended.

For example, the control part 1 instructs the input part 4 to accept input of a key as the first-data decryption information. Then, when the key (first-data decryption information) accepted by the input part 4 and the first-data decryption key are identical to each other, the control part 1 decides that the permission condition is satisfied.

At step S23, the control part 1 decrypts the encrypted first data segment by using the first-data decryption key. In this process, the next-data information of the first data segment is also decrypted. That is, the combined data including the first data segment with the next-data information added thereto is decrypted. As a result, it is made possible to recognize various types of information included in the next-data information such as encryption method, decryption key, storage destination and account.

At step S24, the control part 1 recognizes, as a decryption-targeted data segment to be next decrypted, the data segment (combined data) encrypted on the basis of the encryption method and the decryption key included in the next-data information of the latest-decrypted data segment. In a case where the latest-decrypted data segment is the first data segment, the encrypted second data segment is the decryption-targeted data segment. In another case where the latest-decrypted data segment is the second data segment, the encrypted third data segment is the decryption-targeted data segment. The control part 1 also recognizes the storage destination of the decryption-targeted data segment as well as the account of the storage destination. In addition, the storage destination of the decryption-targeted data segment as well as the account of the storage destination are included in the next-data information of the latest-decrypted data segment.

At step S25, the control part 1 attempts to access the storage destination of the decryption-targeted data segment by using the account of the storage destination. Then, the control part 1 decides whether or not the storage destination of the decryption-targeted data segment has been accessible. As a result, when the control part 1 decides that the storage destination of the decryption-targeted data segment has been accessible, the processing flow moves on to step S26. When the control part 1 decides that the storage destination of the decryption-targeted data segment has been inaccessible, decryption of the decryption-targeted data segment is skipped, the processing flow being ended. For example, in a case where the decryption-targeted data segment is stored in the USB device 200, while the USB device 200 is unset to the information processing device 100, the control part 1 decides that the storage destination of the decryption-targeted data segment has been inaccessible. Also, in another case where the decryption-targeted data segment is stored in any one of the external servers 300, while the relevant external server 300 is unconnected to the wide area network NT, the control part 1 decides that the storage destination of the decryption-targeted data segment has been inaccessible.

At step S26, the control part 1 acquires the decryption-targeted data segment from the storage destination of the decryption-targeted data segment. The decryption-targeted data segment is temporarily stored in the storage part 2.

At step S27, the control part 1 instructs the display part 3 to display an acceptance screen (not shown) for accepting, from the user, input of decryption information for decrypting the decryption-targeted data segment (hereinafter, this decryption information will be referred to as next-data decryption information). Then, an input operation of inputting next-data decryption information is executed on the input part 4.

At step S28, the control part 1 recognizes the decryption key of the decryption-targeted data segment. It is noted that the decryption key of the decryption-targeted data segment is included in the next-data information of the latest-decrypted data segment. Then, on the basis of the decryption key of the decryption-targeted data segment as well as the next-data decryption information currently accepted by the input part 4, the control part 1 decides whether or not the permission condition for permitting the decryption of the decryption-targeted data segment is satisfied. As a result, when the control part 1 decides that the permission condition is satisfied, the processing flow moves on to step S29; otherwise, when the control part 1 decides that the permission condition is not satisfied, this processing flow is ended.

For example, the control part 1 instructs the input part 4 to accept input of a key as the next-data decryption information. Then, when the key (next-data decryption information) accepted by the input part 4 and the decryption key of the decryption-targeted data segment are identical to each other, the control part 1 decides that the permission condition is satisfied.

At step S29, the control part 1 decrypts the decryption-targeted data segment by using the decryption key of the decryption-targeted data segment. In addition, when the key (next-data decryption information) accepted by the input part 4 and the decryption key of the decryption-targeted data segment are not identical to each other, the decryption of the decryption-targeted data segment is skipped. However, in the case where the key (next-data decryption information) accepted by the input part 4 and the decryption key of the decryption-targeted data segment are not identical to each other, with input of the key for decrypting the decryption-targeted data segment accepted once again, when the key (next-data decryption information) accepted once again by the input part 4 and the decryption key of the decryption-targeted data segment are identical to each other, the decryption of the decryption-targeted data segment may be executed.

At step S30, the control part 1 decides whether or not next-data information has been added to the decrypted decryption-targeted data segment. As a result, when the control part 1 decides that next-data information has been added to the decrypted decryption-targeted data segment, the processing flow moves on to step S24. Upon movement to step S24, the control part 1 recognizes, as a new decryption-targeted data segment (decryption-targeted data segment to be next decrypted), the data segment (combined data) encrypted on the basis of the encryption method and the decryption key included in the next-data information of the decrypted decryption-targeted data segment.

At step S30, when the control part 1 decides that no next-data information has been added to the decrypted decryption-targeted data segment, the processing flow moves on to step S31. That no next-data information has been added to the decrypted decryption-targeted data segment means that a final data segment has been added thereto instead of next-data information. That is, it means that decryption of all the plural data segments divided from the original data and encrypted have been completed (successfully done).

At step S31, the control part 1 executes the process of reconstructing the original data from the decrypted plural data segments. Upon completion of the reconstruction of the original data, this processing flow is ended.

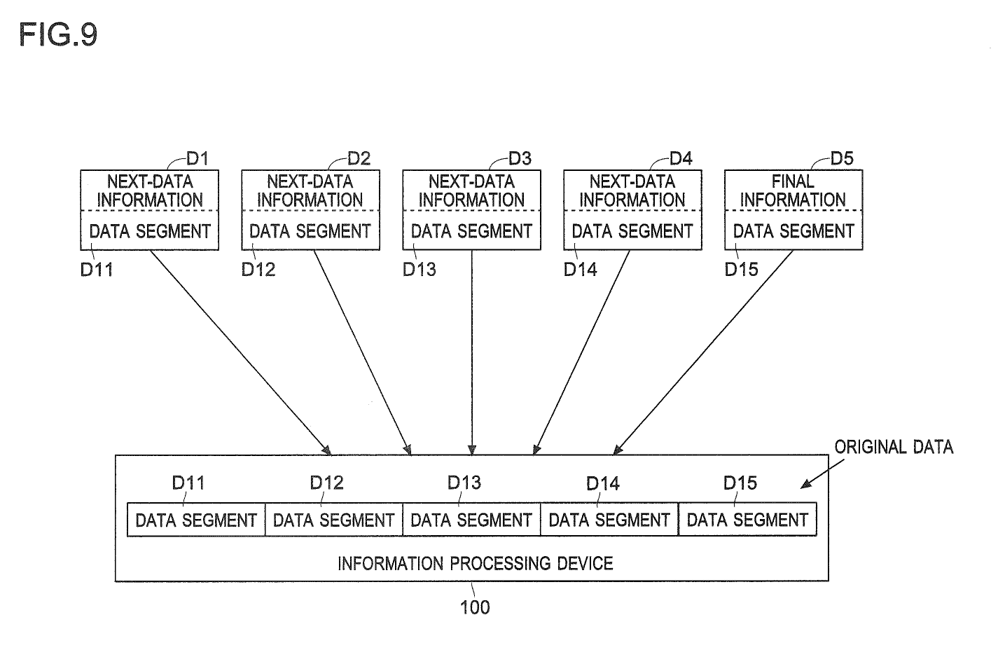

For example, let us assume that the combined data units D1 to D5 are stored in storage destinations different from one another as shown in FIG. 7. In this case, when the reconstruction process (process including decryption process) by the control part 1 is executed, the combined data units D1 to D5 are transferred to the information processing device 100 and decrypted in this order. Then, as shown in FIG. 9, the original data are reconstructed from data segments D11 to D15 of each of the combined data units D1 to D5. However, when decryption has failed with any of the combined data units D1 to D5, neither decryption of the combined data nor reconstruction of the original data will be executed from this on.

As described hereinabove, the information processing device 100 of this embodiment includes: an input part 4 for accepting an input from a user; and a control part 1 for dividing original data into a plurality of data segments and encrypting the plurality of data segments one by one in order. For encryption of an encryption-targeted data segment which is one of the data segments to be currently encrypted, when a next data segment which is one of the data segments to be encrypted next to the encryption-targeted data segment is present, the control part 1 executes steps of: instructing the input part 4 to accept input of an encryption method of the next data segment as well as a decryption key necessary for decryption of the next data segment encrypted by the encryption method; adding, to the encryption-targeted data segment, next-data information including the encryption method of the next data segment and the decryption key of the next data segment; and encrypting the encryption-targeted data segment with the next-data information added thereto in such a fashion that the next-data information is encrypted together therewith, and afterwards for encryption of the next data segment, the control part 1 encrypts the next data segment on a basis of the encryption method and the decryption key included in the next-data information added to the encryption-targeted data segment.

With the constitution of this embodiment, unless a first-encrypted data segment (herein, referred to as first data segment) out of the plural data segments is decrypted, a next-encrypted data segment (herein, referred to as second data segment) cannot be decrypted. The reason of this is that the decryption key (next-data information) necessary for decryption of the encrypted second data segment is encrypted together with the first data segment. Similarly, for decryption of the data segment encrypted next to the second data segment, decryption of the second data segment is necessitated. Therefore, even when a data segment other than the first data segment is acquired by a third party, it is impossible for the third party to decrypt the acquired data segment. As a consequence, any leak of contents of the original data to a third party can be suppressed.

Also in this embodiment, as described above, for encryption of the encryption-targeted data segment, when no encrypted data segment antecedent to the encryption-targeted data segment is present, the control part 1 executes steps of: instructing the input part 4 to accept input of an encryption method of the encryption-targeted data segment as well as a decryption key necessary for decryption of the encryption-targeted data segment encrypted by the encryption method; and encrypting the encryption-targeted data segment on a basis of the encryption method of the encryption-targeted data segment and the decryption key of the encryption-targeted data segment accepted by the input part 4. As a result, the user is allowed to arbitrarily set the encryption method and the decryption key for the data segment to be first encrypted. Consequently, decryption of the first-encrypted data segment can be suppressed.

Also in this embodiment, as described above, for encryption of the encryption-targeted data segment, when no data segment to be encrypted next to the encryption-targeted data segment is present, the control part 1 executes steps of: adding, to the encryption-targeted data segment, final information indicative of the absence of any data segment to be next encrypted, instead of next-data information; and encrypting the encryption-targeted data segment with the final information added thereto in such a fashion that the final information is encrypted together therewith. As a result, in the process of decrypting a plurality of encrypted data segments successively, the control part 1 is enabled to easily decide whether or not all the data segments necessary for reconstruction of the original data have completely been decrypted.

Also in this embodiment, as described above, for encryption of the encryption-targeted data segment, the control part 1 executes steps of: instructing the input part 4 to accept input of a storage destination of the next data segment as well as an account for accessing the storage destination; making the storage destination of the next data segment and the account of the storage destination included in the next-data information which is to be added to the encryption-targeted data segment; and thereafter, after encrypting the next data segment, storing the encrypted next data segment in the storage destination included in the next-data information added to the encryption-targeted data segment. As a consequence, the user is allowed to arbitrarily select the storage destination of an encrypted data segment.

Also in this embodiment, as described above, when having decrypted the data segment encrypted with the next-data information added thereto, the control part 1 executes steps of: recognizing, as a decryption-targeted data segment to be next decrypted, the data segment encrypted on the basis of the encryption method and the decryption key included in the next-data information of the decrypted data segment; instructing the input part to accept input of decryption information for decrypting the decryption-targeted data segment; and, on a basis of the decryption information accepted by the input part, deciding whether or not a permission condition for permitting decryption of the decryption-targeted data segment is satisfied, where when the permission condition is satisfied, the control part 1 decrypts the decryption-targeted data segment by using the decryption key of the decryption-targeted data segment. As a consequence, since correct decryption information needs to be inputted to decrypt a data segment, fraudulent decryption by a third party can be suppressed.

Also in this embodiment, as described above, the control part 1 attempts to access the storage destination of the decryption-targeted data segment by using the account of the storage destination, where when the control part 1 is unable to access the storage destination of the decryption-targeted data segment, the control part 1 skips decryption of the decryption-targeted data segment. As a consequence, for example, even though decryption information for decrypting one data segment has been known by a third party, changing the account of the storage destination of the relevant data segment makes it possible to suppress leak of the contents of the data segment to a third party.

Also in this embodiment, as described above, when having successfully decrypted all the encrypted plural data segments, the control part 1 executes a process of reconstructing the original data from the decrypted plural data segments. As a consequence, the user is enabled to easily obtain the reconstructed original data.

The embodiment disclosed herein should be construed as not being limitative but being an exemplification at all points. The scope of the disclosure is defined not by the above description of the embodiment but by the appended claims, including all changes and modifications equivalent in sense and range to the claims.

What is claimed is:

1. An information processing device comprising:
an input part for accepting an input from a user; and
a control part for dividing original data into a plurality of data segments and encrypting the plurality of data segments one by one in order, wherein
for encryption of an encryption-targeted data segment which is one of the data segments to be currently encrypted, when a next data segment which is one of the data segments to be encrypted next to the encryption-targeted data segment is present, the control part executes steps of: instructing the input part to accept input of an encryption method of the next data segment as well as a decryption key necessary for decryption of the next data segment encrypted by the encryption method; adding, to the encryption-targeted data segment, next-data information including the encryption method of the next data segment and the decryption key of the next data segment; and encrypting the encryption-targeted data segment with the next-data information added thereto in such a fashion that the next-data information is encrypted together therewith, and wherein, afterwards for encryption of the next data segment, the control part encrypts the next data segment on a basis of the encryption method and the decryption key included in the next-data information added to the encryption-targeted data segment.

2. The information processing device according to claim 1, wherein
for encryption of the encryption-targeted data segment, when no encrypted data segment antecedent to the encryption-targeted data segment is present, the control part executes steps of: instructing the input part to accept input of an encryption method of the encryption-targeted data segment as well as a decryption key necessary for decryption of the encryption-targeted data segment encrypted by the encryption method; and encrypting the encryption-targeted data segment on a basis of the encryption method of the encryption-targeted data segment and the decryption key of the encryption-targeted data segment accepted by the input part.

3. The information processing device according to claim 1, wherein
for encryption of the encryption-targeted data segment, when none of the data segments to be encrypted next to the encryption-targeted data segment is present, the control part executes steps of: adding, to the encryption-targeted data segment, final information indicative of the absence of any data segment to be next encrypted, instead of the next-data information; and encrypting the encryption-targeted data segment with the final information added thereto in such a fashion that the final information is encrypted together therewith.

4. The information processing device according to claim 1, wherein
for encryption of the encryption-targeted data segment, the control part executes steps of: instructing the input part to accept input of a storage destination of the next data segment as well as an account for accessing the storage destination; making the storage destination of the next data segment and the account of the storage destination included in the next-data information which is to be added to the encryption-targeted data segment; and thereafter, after encrypting the next data segment, storing the encrypted next data segment in the storage destination included in the next-data information added to the encryption-targeted data segment.

5. The information processing device according to claim 4, wherein
when having decrypted the data segment encrypted with the next-data information added thereto, the control part executes steps of: recognizing, as a decryption-targeted data segment to be next decrypted, the data segment encrypted on the basis of the encryption method and the decryption key included in the next-data information of the decrypted data segment; instructing the input part to accept input of decryption information for decrypting the decryption-targeted data segment; and, on a basis of the decryption information accepted by the input part, deciding whether or not a permission condition for permitting decryption of the decryption-targeted data segment is satisfied, where when the permission condition is satisfied, the control part decrypts the decryption-targeted data segment by using the decryption key of the decryption-targeted data segment.

6. The information processing device according to claim 5, wherein
the control part attempts to access the storage destination of the decryption-targeted data segment by using the account of the storage destination, where when the control part is unable to access the storage destination of the decryption-targeted data segment, the control part skips decryption of the decryption-targeted data segment.

7. The information processing device according to claim 5, wherein
when having successfully decrypted all the encrypted plural data segments, the control part executes a process of reconstructing the original data from the decrypted plural data segments.

8. A control method for an information processing device which divides original data into a plurality of data segments and encrypting the plurality of data segments one by one in order, the method comprising the steps of:
recognizing an encryption-targeted data segment which is one of the data segments to be currently encrypted;
accepting input of an encryption method of a next data segment which is one of the data segments to be encrypted next to the encryption-targeted data segment as well as a decryption key necessary for decryption of the next data segment encrypted by the encryption method;
extracting the encryption-targeted data segment from the original data;
generating combined data composed of the encryption-targeted data segment to which next-data information including the encryption method of the next data segment as well as the decryption key of the next data segment is added; and
encrypting the combined data, wherein
for encryption of the next data segment, the information processing device encrypts the next data segment on a basis of the encryption method and the decryption key included in the next-data information added to the encryption-targeted data segment.
